(19) United States
(12) Patent Application Publication
(10) Pub. No.: US 2025/0116133 A1
(43) Pub. Date: Apr. 10, 2025

(54) FENCE POST

(71) Applicant: Hubble Composites Limited, London (GB)

(72) Inventors: Aditya Patel, London (GB); Aakash Patel, Chicago, IL (US)

(73) Assignee: Hubble Composites Limited, London (GB)

(21) Appl. No.: 18/481,195

(22) Filed: Oct. 4, 2023

(51) Int. Cl. E04H 17/20; B29C 70/52; B29D 99/00; B29K 67/00; B29K 309/08; B29L 31/00; E04H 17/00; E04H 17/04; E04H 17/12

(52) U.S. Cl. CPC E04H 17/20; E04H 17/12; B29C 70/52; B29C 2793/009; B29D 99/0003; B29K 2067/00; B29K 2309/08; B29L 2031/73; E04H 17/017; E04H 17/045

(57) ABSTRACT

The invention relates to a fence post 100 for electrical fences. The fence post 100 may be formed as a pultrusion and may have the shape of a “T”. Compared to prior art fence posts, the fence post 100 can reduce problems of excessive electrical conduction and can also reduce problems of splintering. The fence post 100 may have a tapered region 140. The fence post 100 may have a hole-free region. A portion of the fence post 100 may have a colour that contrasts with the remainder of the fence post 100; this can enhance visibility of the fence post 100 in snow.

### BACKGROUND

The present invention relates to fence posts. The present invention is, in particular (but not exclusively), concerned with fence posts that are suitable for electric fences. Electric fences use electricity to cause an electric shock to animals that attempt to cross a boundary that is defined by the electric fence.

A fence post may be used, for example, as: an anchor post, a line post, or as a spacer as part of a barbed-wire fence system. Fence posts may also be used as brace assemblies for, for example, wire fence systems. Fence posts may also be used in corrals or as part of a gate assembly.

A fence system may be, for example, a high-tensile smooth wire system (whether electric or non-electric), a low tensile smooth wire system, a woven wire system, a plastic net system (whether electric or non-electric), or a rail fence system (whether electric or non-electric).

One problem with fence posts is the selection of a suitable material. Popular materials of choice for the above fence types have traditionally been wood, steel, concrete, plastic (PVC in particular) and fiberglass.

In the 1970s and 1980s, fiberglass rods as posts were introduced in sizeable volumes into the fence market because out-of-service fiberglass sucker rods (from pumpjacks, also known as nodding donkeys, from the oil industry) were repurposed into line posts. This is still the practice to the present time. There are several problems with the use of sucker rods:
(A) The sucker rods are made of unidirectional glass fibres (often without the usage of additional coatings/surface veils)—and this leads to splitting and splintering issues when exposed to ultraviolet light (UV). The exposed fibres can harm animals if they scratch against the posts.
(B) The sucker rods cannot be used as corner posts due to the standard dimensions of sucker rods not being suitable for this use.
(C) It is not safe to use sucker rods for electric fencing purposes because water ingress via the exposed glass can make the posts conductive.

T-posts that are currently on the market are typically made of steel or PVC, Steel T-posts can feature a universal classic design with an anchor plate at the foot along with studs popping out from the horizontal face of the cross-section of the “T”. PVC posts are not as rigid as glass-fiber-composite T-posts and thus are not suitable for use as corner posts (nor as a part of other assemblies mentioned above).

A problem with fence posts is that they can be damaged by impact forces associated with inserting the fence post into the ground. On small farms, farmers may insert fence posts manually, using a hammer to drive the fence post into the ground. On large farms, fence posts may be inserted into the ground using a post-pounding machine that is analogous to a pile driver and which automates the insertion offence posts. The post-pounding machine may be of the hydraulic hammer type, the hydraulic press-in type, or a vibratory type.

The tip of a fence post (that pierces the ground) is particularly susceptible to damage. The ground or soil may contain stones, or other solid debris, that impedes the passage of the fence post into the ground. The stones or debris may be on the surface of the soil or under the surface. A small-sized tip (that is, a tip that has a small effective area) will increase the pressure on the ground, helping the fence post to be inserted. On the other hand, an excessively small tip is susceptible to bending and/or shattering and/or splitting if the soil contains obstacles such as stones. Conversely, a large tip will be stronger than a small tip but will be more difficult to insert into the ground, due to the increased effective area of the tip.

### BRIEF DESCRIPTION OF INVENTION

According to an aspect of the present invention, there is provided a fence post (100) comprising:
a shank (110), wherein the shank (110) has a T-shaped cross-section (300) comprising a stem (120) and a cross-bar (130);
wherein the fence post (100) comprises a composite material formed as a pultrusion.

There is also provided a method according to claim 12.

### FIGURES

FIG. 1 shows a stem-on view of a fence post according to an embodiment of the present invention.

FIG. 2 shows a side-on view of the fence post of FIG. 1.

FIG. 3 shows a cross-sectional through a plane 3-3′ of the fence post of FIG. 1.

FIG. 4 shows a flowchart of a method for manufacturing a fence post.

### DESCRIPTION

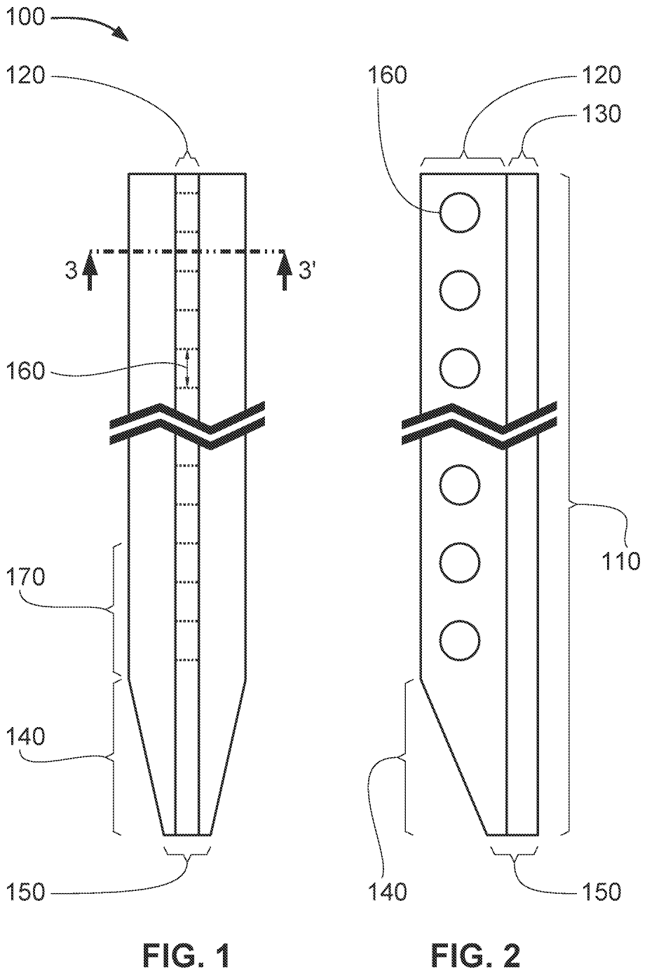

FIG. 1 shows a fence post 100 comprising:
110 a longitudinal shank (for clarity, the shank is labelled in FIG. 2),
120 a stem,
130 a crossbar,
140 a tapered region,
150 a foot,
160 holes in the stem 120.

FIG. 1 shows the fence post 100 viewed stem-on. The shank 110 comprises the stem 120, integrally formed with the crossbar 130.

FIG. 2 shows a side-on (that is, crossbar-on) view of the fence post 100, and shows:
110 the longitudinal shank,
120 the stem,
130 the crossbar,
140 the tapered region,
150 the foot,
160 holes (which may receive an electrified fence wire, not shown),
170 an optional hole-free region.

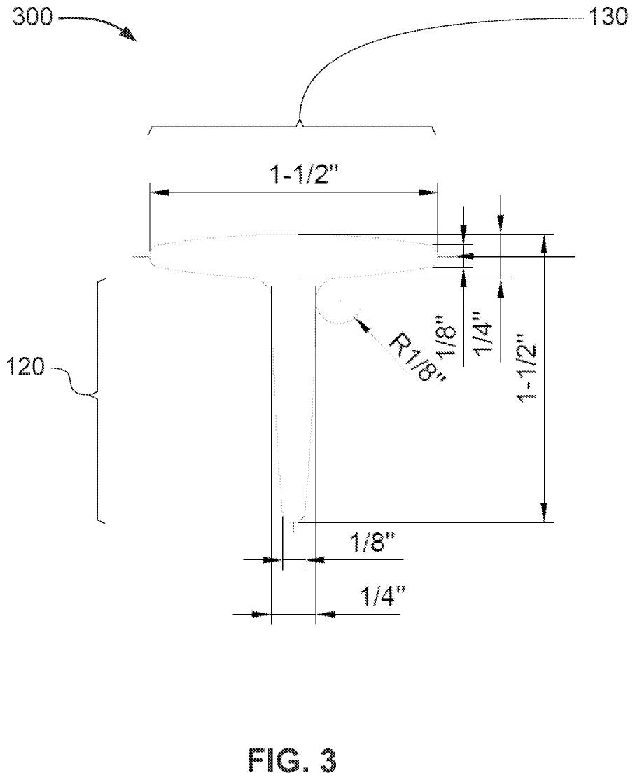

FIG. 3 shows a cross-sectional view 300 through the plane 3-3′ of FIG. 1, and shows:
120 the stem,
130 the crossbar.

With reference to typography, FIG. 3 shows that the cross-section 300 of the fence post 100 has the shape of the letter “T”. The stem 120 forms the stem of the T. The crossbar 130 forms the crossbar (also called an ‘arm’) of the T. FIG. 3 shows that the stem 120 may join the crossbar 130 at the middle of the crossbar 130; the stem 120 may be perpendicular to the crossbar 130.

The length of the shank 110 may be from 1.219 to 3.66 meters (4 to 12 feet).

The size of the crossbar 130 may be from 2.5 centimetres to 10.2 centimetres (1 inch to 4 inches), for example, 1.5 inches (38.1 mm), see FIG. 3. The “height” of the T (that is, the stem 120 added to the thickness of the crossbar 130) may be from 2.5 centimetres to 10.2 centimetres (1 inch to 4 inches), for example, 1.5 inches (38.1 mm), see FIG. 3. The thickness of the stem 120 and/or the thickness of the crossbar 130 may be from 1.58 mm to 12.7 mm ( 1/16 to ½ of an inch). The corners (where the stem 120 joins the crossbar 130) may be radiused; the corner radii may be in the range 1.58 mm to 12.7 mm ( 1/16 to ½ of an inch).

The fence post 100 may be formed by a pultrusion method. A length (for example 1.219 to 3.66 meters) may be cut off from the finished pultrusion. The stem 120, and the crossbar 130 may then be cut or sawed at an angle (relative to the longitudinal axis of the fence post 100) to form the tapered region 140. A drill (not shown) may be used to form the holes 160. Optionally, a coating (for example, containing a black pigment) may be coated onto an upper portion of the fence post 100, for better visibility in snow. A coating (for example the black pigment or a waterproof coating) may be applied to the tapered region 140 and/or to the foot 150 to reduce water ingress from damp soil into the fence post 100. If a coating is applied to the upper portion of the fence post 100 then the same coating may also be applied, at the same time, to the cut portions of the taper region 140 and the foot 150.

The holes 160 may be circular and may have a diameter of 12.7 mm (½ inch). In other embodiments (not shown), one or more of the holes 160 may be replaced with slots.

As those skilled in the art will appreciate, a pultrusion is a composite structure that may be formed of, for example, fiberglass and a plastic matrix. The plastic matrix may be a thermoset polymer mix such as a polyester resin or an epoxy resin, A pultrusion may be formed by impregnating fiberglass with a liquid thermoset polymer, then pulling the impregnated fiberglass through a heated die (not shown). The pultrusion conforms to the shape of the die. The fiberglass may comprise a core (not shown) of strands of fiberglass. The core may, be surrounded (not shown) by a mat of fiberglass and/or by a woven cloth made of fiberglass.

The pultrusion method may be used to form closed shapes such as tubes. Accordingly, although the fence post 100 has been shown having a T-shaped cross section 300, the fence post 100 may comprise a tubular portion (not shown) in which a longitudinal axis of the tube extends along the longitudinal shank 110.

FIGS. 1 and 2 show a tapered region 140, in which the shank 110 tapers towards a foot 150. The fence post 100 preferably has a tapered region 140. The tapered region 140 facilitates insertion of the fence post 100 into ground. The tapered region 140 may have a length of at least 1 centimetre, and may range from 15 cm to 30 cm (0.5 to 1 feet). The foot 150 is a portion of the fence post 100 that is perpendicular to a longitudinal axis of the fence post 100; the foot 150 may have a size of 2 to 4 centimetres. The foot 150 is narrower than the shank 110. The foot 150 has a relatively small area (compared to the bulk of the fence post 100) and facilitates insertion of the fence post 100 into ground. The size (or area) of the foot 150 is preferably sufficient to avoiding splitting of the foot 150 if the foot 150 encounters objects such as stones. The foot 150 may be regarded as being similar to the tip that was mentioned in the background section of this disclosure.

The foot 150 may have an area in the range of 1 to 10 square centimetres. Preferably, the foot 150 has an area in the range 2 to 4 square centimetres. It will be appreciated that the foot 150 may T-shaped; nevertheless, the foot 150 has an effective area which contacts the ground when an uninserted fence post 100 rests foot-down on the ground.

Some embodiments (not shown) of the fence post 100 may omit the foot 150. That is, the fence post 100 may taper to a point, instead of terminating at the foot 150. However, a point would be susceptible to damage. Accordingly, a foot 150 provides a compromise between facilitating insertion of the fence post 100 into ground whilst minimising the risk of damage to the fence post 100.

FIGS. 1 and 2 show that the tapered region 140 may have the same length for the stein 120 and the same length for the crossbar 130. In other embodiments (not shown), a tapered region of the stem 120 may be longer (or shorter) than a tapered region of the crossbar 130, In other embodiments (not shown), only the stem 120 or only the crossbar 130 is tapered. In yet other embodiments (not shown), the tapered region 140 may be omitted, such that the shank 110 has a substantially constant cross-section from a top of the fence post 110, down to the foot 150; in this case, the foot 150 would have same size as the cross-section 300.

The fence post 100 may be manufactured by a pultrusion process. Glass fibres may be dipped into a resin and then pulled through a pultrusion die. The pultrusion die may have a T shape. The pultrusion die may be heated to cure the resin. The glass fibres, together with the resin, conform to the shape of the pultrusion die. The glass fibres may comprise glass roving. The glass fibres may also comprise glass mat and/or woven glass fibres that surround the glass roving; this surrounding can improve the strength and/or the toughness and/or the surface finish of the fence post 100.

The holes 160 may be formed by drilling into the stem 120, after the polymer matrix has set. Only six holes 160 are visible in FIGS. 1 & 2. Preferably, the fence post 100 has at least one hole 160. The fence post 160 may have a total of sixteen holes 160. The holes 160 may be equally spaced along the stem 120.

FIGS. 1 & 2 show the holes 160 extending from a top of the fence post 100 to a tapered region 140. In some embodiments of the fence post 100, there may be a hole-free region 170 at a base of the fence post 100. (Note that FIG. 1 shows two holes 160 in the optional hole-free region 170: it will be appreciated that the two holes 160 may not be present.) For example, there may be a hole-free region 170 having a length of 0.5 metres to 1 metre. The hole-free region 170 will typically be underground, after the fence post 100 has been inserted into ground or soil. A benefit of the hole-free region 170 is that it improves the strength and reduces the manufacturing cost of the fence post 100.

An example composition of the fence post 100 is of 60% by weight of glass fibres and 40% by weight of either an unsaturated polyester resin system, vinyl ester resin system or an epoxy resin system. The glass fibres can vary in type between A C, D, E, ECR, M, S, ECR etc. (E-glass fibres may be selected for their superior electrical properties. Unsaturated polyester resin may be selected for its relatively low cost and relatively high strength.) The glass may be used in the form of rovings or stitched mats or woven fabrics. The linear density of rovings may be between 600 tex to 9600 tex. The areal weight of mats or fabrics may be between 150 gsm to 600 gsm (grammes per square metre). Non-woven surface veils may be used to improve the surface finish and/or prevent splintering and/or for UV protection. (The fiberglass sucker rods that were mentioned above, when repurposed as electric fence line posts, do not include these mats or woven fabrics due to their designed primary use in the longitudinal direction in sucker rod pumps.)

The resin mix may comprise one or more fillers such as those listed below (with their purpose stated):
Aluminium Trihydrate (fire retardant filler)
Antimony trioxide (flame retardant filler)
Calcium carbonate (rheology control)
Decabromo diphenyl ethane (fire retardant filler)
Titanium dioxide (rheology control, pigment)
Cobalt octoate (catalyst)
Copper nathanate (retarder)
Dimethyl aniline (accelerator)
Release agent (blends of organic fatty acids, esters and amine neutralizing agents)
tert-Butyl peroxybenzoate (initiator)
2-(2-hydroxy-5-methylphenyl) benzotriazole (UV absorber)
Bis(2,2,6,6-tetramethyl-4-piperidyl) sebacate (hindered amine light stabilizer)
Pigment
Hollow glass spheres (rheology control)
Impact modifiers (impact resistance)

An impact modifier may be added to the resin mix to improve the impact resistance of the fence post 100. An example of an impact modifier, suitable for polyester resins, is maleic anhydride. The impact modifier may be added in the range 5% to 10% by weight, or 10% to 15%, or 15% to 20%, or 25% to 30%.

Another example of an impact modifier is particles that have a low glass transition temperature (Tg) rubber core that is coated with a shell of a higher Tg polymer. The core of the particles may be butadiene or acrylic. The shell of the particles may be polymethyl methacrylate (PMMA).

The fence post 100 may have a white or green colour.

Some embodiments of the fence post 100 may have an uppermost portion (the opposite end to the foot 150) that is dark or is black, for better visibility of the fence post 100 in snow. However, some black (or dark grey) pultrusion pigments contain carbon black. Carbon black is electrically conductive which could reduce the electrical insulation property of the fence post 100.

Accordingly, to provide fence posts 100 that contrast against snow, light (or white) fence posts 100 may be manufactured, then afterwards coated with a polymer resin (for example polyester resin or epoxy resin) containing a dark pigment. By coating a fence post 100 with a dark (or black) coating after the fence post 100 has been pultruded, the dark coating is only on a surface portion of the fence post 100 (instead of forming the bulk of the polymer matrix of the fence post 100). The fencepost may be coated with a layer of polyurethane coating having a thickness in the range of 5 to 15 microns thickness for superior weather resistance and for a smoother surface finish.

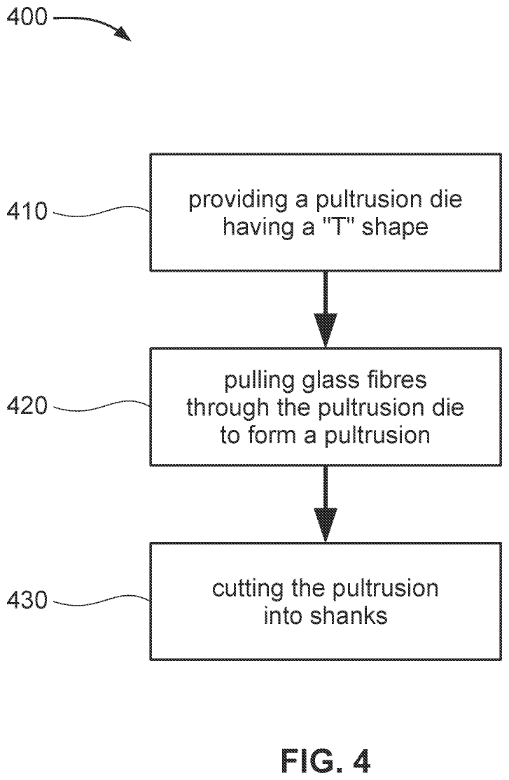

FIG. 4 shows a flowchart of a method for manufacturing a fence post 100.

The reference numerals in the claims are for the convenience of the relevant searching authority and are not to be regarded as limiting the scope of the claims.

The abstract as filed is hereby included by reference.

1. A fence post (100) comprising:
a shank (110), wherein the shank (110) has a T-shaped cross-section (300) comprising a stem (120) and a cross-bar (130);
wherein the fence post (100) comprises a composite material formed as a pultrusion;
wherein the shank (110) has a tapered region (140) at one end of the shank (110);
wherein the composite material comprises an impact modifier to provide impact resistance, and comprises E-glass fibres and unsaturated polyester resin, and wherein the E-glass fibres are axially aligned with a longitudinal axis of the shank (110);
wherein the cross-bar (130) has a width of 2.5 to 10.2 centimetres, the stem (120) has a height of 2.5 to 10.2 centimetres, the shank (110) has a length of 1.219 to 3.66 metres, and the tapered region (140) has a length of 1 to 30 centimetres; and
wherein the shank (110) has a thickness in the range of 1.58 to 12.8 millimetres.

2. A fence post (100) according to claim 1, wherein the shank (110) has a foot (150).

3. A fence post (100) according to claim 2, wherein the foot (150) has an area in the range 1 to 10 square centimetres.

4. A fence post (100) according to claim 1, wherein the shank (110) has holes (160).

5. A fence post (100) according to claim 4, wherein the holes (160) are circular.

6. A fence post (100) according to claim 4, wherein the holes (160) are in the stem (120).

7. A fence post (100) according to claim 4, wherein the shank (110) has a hole-free region (170).

8. A fence post (100) according to claim 1, wherein the composite material of the fence post (100) comprises glass rovings.

9. A fence post (100) according to claim 1, wherein the composite material of the fence post (100) comprises glass stitched mats and/or glass woven fabric.

10. A fence post (100) according to claim 1, comprising a pigmented layer that is formed over the pultrusion.

11. A fence post (100) according to claim 1, wherein the composite material comprises a stabilizer and/or surface veil and/or additional coating, to protect the composite material against ultraviolet light.

12. A method of forming a fence post (100), comprising:
receiving a pultrusion die having a “T” shape;
pulling glass fibres through the pultrusion die to form a pultrusion; and
cutting the pultrusion into shanks (110).

13. A method according to claim 12, further comprising the step of:
coating at least a portion of a shank (110) with pigmented resin
